(19) United States
(12) Patent Application Publication
(10) Pub. No.: US 2004/0217567 A1
(43) Pub. Date: Nov. 4, 2004

(54) Torsion Bar Cross Member Skid Plate

(75) Inventor: Jack Kendell Post, Clayton, CA (US)

Correspondence Address: JACK POST, 985 KENSTON DR., CLAYTON, CA, 94517, US

(73) Assignee: Jack Kendell Post, Clayton, CA (US)

(21) Appl. No.: 10/249,713

(22) Filed: May 2, 2003

(51) Int. Cl. B60G 21/055

(52) U.S. Cl. 280/124.107

(57) ABSTRACT

Aftermarket lift kits move the torsion bar cross member to the bottom of the frame in order to keep the torsion bars parallel to the frame. This makes them susceptible to damage from objects such as rocks when driving off road. The skid plate protects the cross member from being damaged or even torn off while driving over rough terrain.

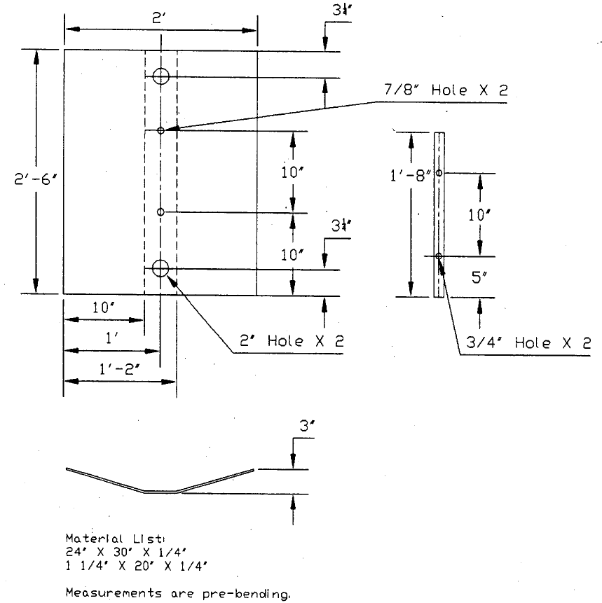

### DETAILED DESCRIPTION

The Torsion Bar Skid Plate, or Skid Plate, is used to protect the torsion bar cross member on 4 wheel drive Chevrolet and GMC K1500 and K2500 trucks with independent front suspension (IFS) and a aftermarket suspension lift. The suspension lift lowers the torsion bar cross member below the frame and creates a clearance problem. The Skid Plate protects the cross member.

There are 2 parts to the Skid Plate. One is the actual skid plate which is a piece of ¼″×24″×30″ steel plate with 4 holes and 2 17° bends. The two ⅞″ holes are for mounting the Skid Plate to the cross members and the two 2″ holes are for access to the torsion bar adjusting bolts. The second is a piece of ¼″×1 ½″ steel with two ¾″ holes and has a ¾″ grade 8 nut welded over each hole. The second piece is welded to the torsion bar cross member and the Skid Plate is bolted to it with 2 grade 8 bolts included with the Skid Plate.

1. Aftermarket lift kits move the torsion bar cross member to the bottom of the frame in order to keep the torsion bars parallel to the frame. This makes them susceptible to damage from objects such as rocks when driving off road. The skid plate protects the cross member from being damaged or even torn off while driving over rough terrain.
